(19) United States
(12) Patent Application Publication
(10) Pub. No.: US 2022/0237912 A1
(43) Pub. Date: Jul. 28, 2022

(54) SYSTEM AND METHOD FOR DETERMINING SOIL CHARACTERISTICS PROFILE

(71) Applicants: Krishna Kant Agrawal, Gautam Buddh Nagar (IN); Devesh Mishra, Prayagraj (IN); Munish Sabharwal, Gautam Buddh Nagar (IN); Amit Kumar Goel, Gautam Buddh Nagar (IN); Galgotias University, Gautam Buddh Nagar (IN)

(72) Inventors: Krishna Kant Agrawal, Gautam Buddh Nagar (IN); Devesh Mishra, Prayagraj (IN); Munish Sabharwal, Gautam Buddh Nagar (IN); Amit Kumar Goel, Gautam Buddh Nagar (IN)

(21) Appl. No.: 17/722,930

(22) Filed: Apr. 18, 2022

(51) Int. Cl. G06V 20/10; B64C 39/02; G08G 5/00; A01B 79/00

(52) U.S. Cl. CPC G06V 20/188; B64C 39/024; B64C 2201/12; A01B 79/005; G08G 5/0034

(57) ABSTRACT

A system for maintaining soil characteristics for a geographical region is described, the system includes of a processing unit connected to the sensing unit for comparing the plurality of soil characteristics determined by the sensing unit with a predefined soil characteristic value stored in a database to determine the soil characteristics, wherein if the plurality of soil characteristics deviate from the predefined soil characteristic value, then the plurality of compared soil characteristics are adjusted to match with the predefined soil characteristics; and a prediction and recommendation unit connected with the processing unit for predicting at least a disease based on the deviated soil characteristics and generating recommendations for maintaining the deviated soil characteristics to make the soil ideal for crops and reduce risk of the predicted diseases.

### TECHNICAL FIELD

The present disclosure relates to a field of agriculture and in particularly relates to a system for determining and maintaining soil characteristics for a geographical region.

### BACKGROUND

Agricultural growing operations operate efficiently when, among other things, seeds are planted in soil having optimal soil characteristics and the seeds are provided optimal amounts water and nutrients. Soil characteristics (e.g., soil composition, soil density, nutrient presence, humus presence, etc.) vary from location to location, both globally (e.g., from geographic region to geographic region) and locally (e.g., from spot to spot within a single area of land). Further, the presence of soil moisture from natural sources or from man-made irrigation systems, varies from location to location.

Generally, a single agricultural growing operation involves planting a specific type of seed according to a set pattern over many acres of land (e.g., planting a field of corn in rows). Soil characteristics will often vary over the area of land used for the agricultural growing operation. Despite the variances in soil characteristics, seeds are generally planted in the same manner across the entire area of land used for growing operation. Further, many agricultural growing operations utilize man made delivery systems for water, nutrients, fertilizers, and/or other chemicals and soil additives. The delivery systems are buried or placed on the surface of the soil. The delivery systems are at risk of being damaged or destroyed as agricultural equipment disturbs the soil to plants seeds, harvests crops, and tills soil material.

In one solution, apparatus for detecting soil characteristics includes a vehicle and a controller coupled to the vehicle. The apparatus further includes a planting device coupled to the vehicle, the planting device configured to plant seeds or plants into a soil material. The apparatus includes a ground penetrating radar sensor coupled to the vehicle. The ground penetrating radar soil sensor is configured to scan the soil material up to a designated depth beneath a surface of the soil material, wherein the ground penetrating radar soil sensor is further configured to provide a sensor feedback signal to the controller with respect to an intrinsic characteristic of the soil material. The controller is configured to instruct placement of a seed or a plant into the soil material based on the feedback signal.

In another solution, a control and monitoring system for an agricultural planting system comprising a plurality of row units, the control and monitoring system includes a processing unit; an electronic sensor in communication with the processing unit and adapted to sense a characteristic associated with seed planting, wherein the sensor generates a signal associated with the sensed characteristic and the processing unit receives the signal; and a memory associated with the processing unit, said memory storing a data pair comprising the sensed characteristic and a GPS position of the sensed characteristic, and wherein the data pair is used for analysis and later retrieval.

In another solution, a soil characteristics survey device for surveying soil characteristics, includes a soil excavator for excavating and moving into a given soil while making its excavating surface get in contact with the soil at any given depth, and forming a survey space on an opposite side of a direction of movement of the excavating surface; a detecting device; a distance recognizing device; and a distance corresponding device, wherein said detecting device measures characteristics of the soil on a survey surface which is on an interface between the survey space and the soil, said distance recognizing device recognizes the distance from said detecting device to the survey surface, and said distance corresponding device performs an information process about soil characteristics detected by said detecting device, according to the distance recognized by said distance recognizing device.

In another solution, soil detection and planting apparatus includes a vehicle; a controller coupled to the vehicle; a planting device coupled to the vehicle, the planting device configured to plant seeds or plants into a soil material; a ground penetrating radar soil sensor coupled to the vehicle, the ground penetrating radar soil sensor configured to scan the soil material up to a designated depth beneath a surface of the soil material, wherein the ground penetrating radar soil sensor is further configured to provide a sensor feedback signal to the controller with respect to an intrinsic characteristic of the soil material; and wherein the controller is configured to determine a designated planting location in the soil material based on the sensor feedback signal, and instruct placement of a seed or a plant into the soil material at the designated planting location.

Therefore, in order to overcome the limitation of the above mentioned prior arts, there exists a need for developing a simple process to synthesize graphene nanosheets by taking the inexpensive carbonaceous material without involving any toxic and hazardous chemicals. The technical advancements disclosed by the present disclosure overcomes the limitations and disadvantages of existing and conventional systems and methods.

### BRIEF SUMMARY

The present disclosure generally relates to a system for determining and maintaining soil characteristics for a geographical region.

An object of the present disclosure is to provide a smart Sensor Network Based Soil characteristics determination and maintenance.

Another object of the present disclosure is to monitor PH value, moisture content, and light intensity of the soil.

Another object of the present disclosure is to provide early warning about a predicted disease.

Yet another object of the present disclosure is to provide a recommendation system for ideal crop growth based on soil characterisctics analysis.

In an embodiment, a system for determining and maintaining soil characteristics for a geographical region, the system comprising: a housing includes a display unit, wherein said display unit displays readings corresponding to the characteristics of the soil of the geographical region visible to a user; a sensing unit disposed within the housing for determining a plurality of soil characteristics in the geographical region; a processing unit connected to the sensing unit for comparing the plurality of soil characteristics determined by the sensing unit with a predefined soil characteristic value stored in a database to determine the soil characteristics, wherein if the plurality of soil characteristics deviate from the predefined soil characteristic value, then the plurality of compared soil characteristics are adjusted to match with the predefined soil characteristics; and a prediction and recommendation unit connected with the processing unit for predicting at least a disease based on the deviated soil characteristics and generating recommendations for maintaining the deviated soil characteristics to make the soil ideal for crops and reduce risk of the predicted diseases.

In an embodiment, wherein said housing is fixedly secured on supporting platforms of the drone, wherein the drone configured to maintain a flight path based on co-ordinates of a global positioning system and to reach over a testing area among the plurality of testing areas found within the geographical region, wherein the geographical region is represented using the global positioning system and co-ordinates of each testing area of the plurality of testing areas are within the coordinates of the geographical region.

In an embodiment, wherein the sensing unit comprising a pH meter and a moisture meter to facilitate the instant reading of the pH meter and the moisture meter.

In an embodiment, wherein a drone includes a drone controller comprising a drone controller configured to communicate with the at least one remote communication device to identify the plurality of testing areas and determine the flight path in accordance with the identified plurality of testing areas, wherein the drone controller is configured to fly to a next testing area upon completion of transmission of the information of a current testing area to the at least one remote communication device.

In an embodiment, a first communication unit is interconnected with the prediction and recommendation unit and the display unit for displaying the disease prediction and the recommendation, wherein a second communication unit is interconnected with display unit and the sensing unit for displaying the sensed data.

In an embodiment, the housing comprises: an opening placed on a base; and a shaft passing through the first opening, wherein a first end of the shaft is coupled to a soil leveler motor and a second end of the shaft is coupled to a circular plate which upon activation is configured to maintain a horizontal level of an upper surface of the soil by undergoing a rotary motion on soil surface within which the at least two retractable electrodes are inserted causing even placement of the at least two retractable electrodes within the soil.

In an embodiment, wherein said shaft comprises at least one proximity sensor installed at another end of the shaft to detect the presence of the soil surface near to the shaft, wherein upon detection of the presence of the soil surface, the linear actuator is configured to cease the movement of the shaft in the forward direction.

In an embodiment, the plurality of characteristics includes determining pH value of the soil, moisture percentage within the soil and intensity of light at the testing area found within the geographical region. To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a system for maintaining soil characteristics for a geographical region,

FIG. 2 shows a schematic diagram of a system for determining the profile of soil in geographical region following an embodiment of the present disclosure, and

FIG. 3 shows a schematic diagram of a drone with the apparatus for determining the profile of soil in geographical region in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying drawings.

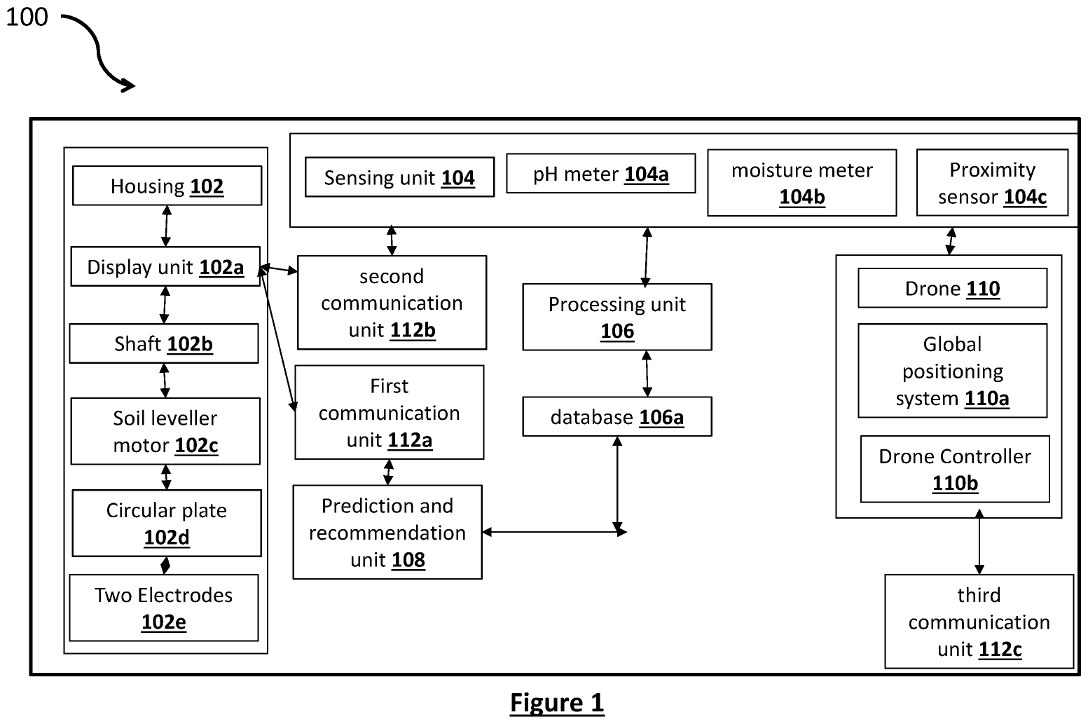

FIG. 1 illustrates a block diagram of a system (100) for maintaining soil characteristics for a geographical region, the system (100) comprising: a housing (102), a display unit (102a), a shaft (102b), a soil leveler motor (102c), a circular plate (102d), two retractable electrodes (102e), a sensing unit (104), a pH meter (104a), a moisture meter (104b), proximity sensor (104c), a processing unit (106), database (106a), a prediction and recommendation unit (108), a drone (110), a global positioning system (110a), a drone controller (110b), a first communication unit (112a), a second communication unit (112b), and a third communication unit (112c).

The housing (102) includes a display unit (102a), wherein the display unit (102a) displays readings corresponding to the characteristics of the soil of the geographical region visible to a user. The housing (102) is fixedly secured on supporting platforms of a drone (110), wherein the drone (110) is configured to maintain a flight path based on co-ordinates of a global positioning system (110a) and to reach over a testing area among the plurality of testing areas found within the geographical region, wherein the geographical region is represented using the global positioning system and co-ordinates of each testing area of the plurality of testing areas are within the coordinates of the geographical region.

The housing (102) comprises: an opening placed on a base; and a shaft (102b) passing through the first opening, wherein a first end of the shaft (102b) is coupled to a soil leveler motor (102c) and a second end of the shaft is coupled to a circular plate (102d) which upon activation is configured to maintain a horizontal level of an upper surface of the soil by undergoing a rotary motion on soil surface within which at least two retractable electrodes (102e) are inserted causing even placement of the at least two retractable electrodes (102e) within the soil.

The sensing unit (104) disposed within the housing (102) for determining a plurality of soil characteristics in the geographical region. The sensing unit (104) comprising a pH meter (104a) and a moisture meter (104b) to facilitate the instant reading of the pH meter (104a) and the moisture meter (104b). The plurality of characteristics includes determining pH value of the soil, moisture percentage within the soil and intensity of light at the testing area found within the geographical region.

The processing unit (106) is connected to the sensing unit (104) for comparing the plurality of soil characteristics determined by the sensing unit (104) with a predefined soil characteristic value stored in a database (106a) to determine the soil characteristics, wherein if the plurality of soil characteristics deviate from the predefined soil characteristic value, then the plurality of compared soil characteristics are adjusted to match with the predefined soil characteristics.

The prediction and recommendation unit (108) is connected with the processing unit (106) for predicting at least a disease based on the deviated soil characteristics and generating recommendations for maintaining the deviated soil characteristics to make the soil ideal for crops and reduce risk of the predicted diseases.

The drone (110) includes a drone controller (110b) configured to communicate with a third communication unit (112c) to identify the plurality of testing areas and determine the flight path in accordance with the identified plurality of testing areas, wherein the drone controller (110b) is configured to fly to a next testing area upon completion of transmission of the information of a current testing area to the third communication unit (112c).

The shaft (102b) comprises at least one proximity sensor (104c) installed at another end of the shaft (102b) to detect the presence of the soil surface near to the shaft (102b), wherein upon detection of the presence of the soil surface, the linear actuator is configured to cease the movement of the shaft (102b) in the forward direction.

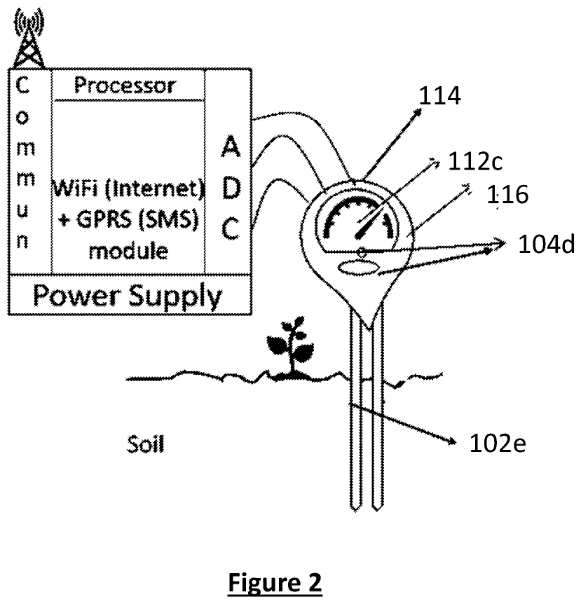

FIG. 2 shows a schematic diagram of a system for determining the profile of soil in geographical region following an embodiment of the present disclosure. The apparatus includes a first compartment 114, a display unit 102a, two electrodes 102e, a third communication module 112c, and a light sensor 104d. The first compartment 114 having a transparent portion 116 so that the user easily able to see readings from the display unit 102a. The compartment 114 includes the display unit 102a and a sensing unit 104. The sensing unit 104 is coupled with the two electrodes 102e. These electrodes 102e include a PH measuring electrode and moisture measuring electrode. These electrodes 102e put inside the soil for measuring the PH value and moisture content of the soil. The PH measuring electrode relies on a voltage test to determine hydrogen ion levels and thus pH. The more hydrogen ions in a solution, hence the more acidic a solution, and the more electricity is conducted. When both the electrodes 102e come in contact with the soil then the voltage difference between the two electrodes is sent as a signal. This signal acts upon an electromagnetic coil which causes the needle to rotate about its hinge and give a pH reading on the scale.

The signals from the electrodes 102e send to the sensing unit 104. The sensing unit 104 processes the signal and shows the signal on the display unit 102a. The light sensor 104d is fixed on the outer side of the first compartment 114. The light sensor 104d is adapted to measure light intensity and is coupled with the sensing unit for sensing the sensed signal to the digital unit 102a.

The first compartment 114 is coupled with the second communication module 112b. The second communication module 112b includes a processor, a power source a GPRS module, an Analog to Digital Converter (ADC). The power source provides power to the first compartment 114 for measuring the PH, moisture content, and light intensity of the soil. The signals are transferred to the ADC that converts the signal from analog to digital. The signals are further transmitted on a mobile phone of the user with the help of the General Packet Radio Service (GPRS) module. The GPRS module includes a nano sim for providing all information to the user. The user also sends information to the first compartment 102 through the GPRS module. In communication module 112b, a ESP32 development board combines a SIM800L GSM/GPRS module. Besides Wi-Fi and Bluetooth, the user communicates with this ESP32 board using SMS or phone calls and connects to the internet using the SIM card data plan.

In an embodiment, the apparatus is attached to the drone. The drone provides the apparatus on the farms at particular coordinates for monitoring PH value, moisture content, and light intensity of the soil.

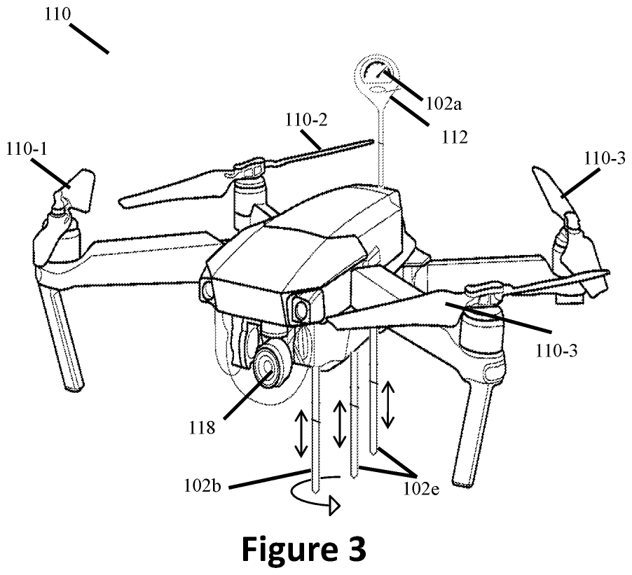

FIG. 3 shows a schematic diagram of a drone with the apparatus for determining the profile of soil in geographical region in accordance with an embodiment of the present disclosure. The drone 110 comprises a plurality of rotors 110-1, 110-2, 110-3, and 110-4 to provide thrust to the drone 110 for traveling via air. A camera 118 is also shown in the figure. The camera 118 provides a front view of drone 110 to the user through the communication module. Further, a retractable shaft 102b present at the lower side of the drone 110. When there is the use of the shaft 102b then the drone controller puts down the shaft 102b within the soil for making a cylindrical hole so that the electrodes 102e get easily placed within the soil. The retractable shaft 102b is coupled to a soil extractor motor. Clockwise rotation of the shaft 102b causes the insertion of the shaft 102b within the soil surface and anti-clockwise rotation of the shaft 102b causes extraction of shaft 102b from the surface of the soil causing a cylindrical hole within the soil surface. The two electrodes 102e are retractable in nature. Where there is the use of these electrodes 102e then the drone controller puts down the electrodes 102e inside the cylindrical hole within the soil surface for determining Ph value and moisture content. The sensing unit 112 is linked with the electrodes 102e and the display unit 102a. The sensing unit 112 is configured to sense the output from the electrodes 102e. The display panel 124 is adapted to show the output of the electrodes 102e.

In an embodiment, the soil extractor motor provides power to the retractable shaft 102b. The shaft 102b drills a cylindrical hole inside the soil by rotating the shaft 102b in clockwise direction. The apparatus includes a soil extractor powered by the battery. The soil extractor rotates in anticlockwise direction for extracting soil from the cylindrical hole on the surface of the soil. The apparatus includes a circular plate powered by the battery. The circular plate converts soil surface from rough surface to plane surface by removing the soil around the cylindrical hole. The plane surface helps to stabilize the drone 110 on the surface of the soil. When the drone 110 comes in contact with the soil, the drone 110 gets stabilized by placing the electrodes 102e inside the space that make by extracting soil from the surface. These electrodes 102e are placed inside the space for measuring ph value and moisture content of the soil. In an exemplary implementation of the present disclosure, the soil extractor motor is powered by the battery.

In an embodiment, the plane surface of the soil provides comfortable landing of the drone 110 on the soil surface by placing the electrode 102e inside the space. If the plain surface of the soil is not present then the electrodes 102e are not able to measure exact value of PH and moisture level inside the soil.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for maintaining soil characteristics for a geographical region, the system comprising:
a housing includes a display unit, wherein the display unit displays readings corresponding to the characteristics of the soil of the geographical region visible to a user;
a sensing unit disposed within the housing for determining a plurality of soil characteristics in the geographical region;
a processing unit connected to the sensing unit for comparing the plurality of soil characteristics determined by the sensing unit with a predefined soil characteristic value stored in a database to determine the soil characteristics, wherein if the plurality of soil characteristics deviate from the predefined soil characteristic value, then the plurality of compared soil characteristics are adjusted to match with the predefined soil characteristics; and
a prediction and recommendation unit connected with the processing unit for predicting at least a disease based on the deviated soil characteristics and generating recommendations for maintaining the deviated soil characteristics to make the soil ideal for crops and reduce risk of the predicted diseases.

2. The system of claim 1, wherein said housing is fixedly secured on supporting platforms of a drone, wherein the drone is configured to maintain a flight path based on co-ordinates of a global positioning system and to reach over a testing area among the plurality of testing areas found within the geographical region, wherein the geographical region is represented using the global positioning system and co-ordinates of each testing area of the plurality of testing areas are within the coordinates of the geographical region.

3. The system of claim 1, wherein the sensing unit comprising a pH meter and a moisture meter to facilitate the instant reading of the pH meter and the moisture meter.

4. The system of claim 1, wherein a first communication unit is interconnected with the prediction and recommendation unit and the display unit for displaying the disease prediction and the recommendation, wherein a second communication unit is interconnected with display unit and the sensing unit for displaying the sensed data.

5. The system of claim 1, wherein the drone includes a drone controller configured to communicate with a third communication unit to identify the plurality of testing areas and determine the flight path in accordance with the identified plurality of testing areas, wherein the drone controller is configured to fly to a next testing area upon completion of transmission of the information of a current testing area to the third communication unit.

6. The system of claim 1, wherein the housing comprises:
an opening placed on a base; and
a shaft passing through the first opening, wherein a first end of the shaft is coupled to a soil leveler motor and a second end of the shaft is coupled to a circular plate which upon activation is configured to maintain a horizontal level of an upper surface of the soil by undergoing a rotary motion on soil surface within which at least two retractable electrodes are inserted causing even placement of the at least two retractable electrodes within the soil.

7. The system of claim 6, wherein said shaft comprises at least one proximity sensor installed at another end of the shaft to detect the presence of the soil surface near to the shaft, wherein upon detection of the presence of the soil surface, the linear actuator is configured to cease the movement of the shaft in the forward direction.

8. The system of claim 1, wherein the plurality of characteristics includes determining pH value of the soil, moisture percentage within the soil and intensity of light at the testing area found within the geographical region.
